(19) United States
(12) Patent Application Publication
(10) Pub. No.: US 2026/0285652 A1
(43) Pub. Date: Sep. 24, 2026

(54) MOBILE CRANE DRIVE TRAIN WITH AN ELECTRIC DRIVE

(71) Applicant: Manitowoc Crane Group France SAS, Dardilly (FR)

(72) Inventors: Andreas Krug, Oldenburg (DE); Dieter Stührwoldt, Wilhelmshaven (DE)

(21) Appl. No.: 19/567,861

(22) Filed: Mar. 16, 2026

(30) Foreign Application Priority Data
Mar. 21, 2025 (DE) 102025110974.5

(51) Int. Cl. B66C 23/40; B60K 25/00; B60K 25/06

(52) U.S. Cl. CPC B66C 23/40; B60K 25/06; B60K 2025/005

(57) ABSTRACT

The present disclosure relates to a mobile crane drive train for supplying power to a traction drive, including:
an internal combustion engine for providing drive power;
at least two driven chassis axles; and
a transfer gearbox arranged between the internal combustion engine and the chassis axles and splits the power provided by the internal combustion engine between the chassis axles and includes a drive coupled to the internal combustion engine, and two outputs which are each coupled to at least one chassis axle, and
   wherein the transfer gearbox is coupled via another drive to a motor-generator configured to selectively supply power to the drive train or receive power from the drive train. The present disclosure also relates to a method for controlling a mobile crane drive train and to a mobile crane including the drive train and a control device configured to perform such a method.

### FIELD OF THE DISCLOSURE

The present disclosure relates to a mobile crane drive train for supplying power to the mobile crane traction drive, wherein the drive train includes an internal combustion engine, at least two driven chassis axles and a transfer gearbox for splitting the power provided by the internal combustion engine between the chassis axles. The present disclosure also relates to a method for controlling such a drive train and to a mobile crane including such a drive train.

### BACKGROUND

Mobile cranes include a traction drive for road transport between sites of operation. A diesel engine usually provides the power needed to drive the chassis axles. In so-called “all-terrain” mobile cranes, not only do one or more axles arranged in the rear region of the chassis possess a drive, but also one or more axles arranged in the front region of the chassis possess a drive, in order to achieve a certain degree of off-road mobility, wherein the power transmitted from the internal combustion engine via a drive shaft is split by means of a transfer gearbox between a front and a rear drive train which extend to the respective chassis axles.

Driven by the desire to enable cranes to be operated emission-free, recent efforts in the field of mobile cranes have focused on the use of hybrid drive designs which include not only the internal combustion engine, but also an electric motor as an additional energy converter for providing or drawing mechanical power. Hybrid drive designs also promise improved emission characteristics in the region of the traction drive. WO 2023/104562 discloses a construction machine and/or material handling machine including an internal combustion engine by means of which one or more consumers are driven via a mechanical drive train. In addition to the internal combustion engine, an electric drive for driving the mechanical drive train is provided.

### SUMMARY

It is the object of the present disclosure to provide a mobile crane drive train, for supplying power to the traction drive, which integrates an electric drive into a conventionally designed mobile crane drive train in a straightforward manner and so enables an efficient hybrid drive design for a mobile crane.

In an aspect, the mobile crane drive train in accordance with the present disclosure for supplying power to the traction drive includes an internal combustion engine for providing drive power, at least two driven chassis axles and a transfer gearbox which is arranged between the internal combustion engine and the chassis axles and splits the power provided by the internal combustion engine between the chassis axles. For this purpose, the transfer gearbox includes a drive, which is coupled to the internal combustion engine, and two outputs which are each coupled to at least one chassis axle. In accordance with the present disclosure, the transfer gearbox includes at least one other drive, via which, and in particular, via each of which it is coupled to at least one motor-generator which can selectively supply power to the drive train or receive power from the drive train. For the sake of simplicity, this additional drive is often referred to in the following as a “drive”, although it could also be referred to as an output (power take-off) when the motor-generator is operated as a generator.

In other words, the drive train in accordance with the present disclosure is implemented by connecting up a motor-generator to the existing transfer gearbox for the traction drive, such that it can deliver or receive shaft power via a drive shaft or output shaft of the transfer gearbox. In solutions for retrofitting existing mobile cranes in particular, a power take-off (PTO) of the transfer gearbox (hitherto used for mechanical or hydraulic drives) can be utilized in order to connect up the motor-generator. Within this context, the drive design in accordance with the present disclosure avoids complex redevelopments or extensive retrofits, since in the simplest scenario, connecting up a motor-generator into a conventional drive train of a mobile crane traction drive can include alternatively coupling the motor-generator to a PTO of the transfer gearbox hitherto used in a different way. In the most complex scenario, this is enabled by simply replacing the existing transfer gearbox with a transfer gearbox comprising an additional PTO.

In accordance with one embodiment, the transfer gearbox is permanently coupled to the motor-generator. In order to vary, in accordance with requirements, the shaft power delivered from the motor-generator to the transmission or received via the transmission, the motor-generator includes power electronics. If, for example, an energy storage device or rechargeable battery which is fed via the motor-generator is already fully charged, the power electronics can reduce the charging power to zero.

In an alternative embodiment of the present disclosure, the transfer gearbox is separably coupled to the motor-generator. A coupling which is provided for this purpose can for example be arranged between the additional drive of the transfer gearbox and the rotor shaft of the motor-generator. The motor-generator can for example be mechanically separated from the transfer gearbox by way of a frictional-fit coupling. Within the framework of the present disclosure, however, a positive-fit coupling (in particular a claw coupling) for completely separating the force fit between the transfer gearbox and the motor-generator is preferable. Since it would then be possible to engage or disengage the coupling only when the shafts to be coupled are at a stop or rotating synchronously, it is also conceivable within this context for the motor-generator to be actuated or regulated such that the shafts to be coupled are synchronously rotating when engaging and disengaging the coupling or such that the positive-fit coupling is switched with zero torque by correspondingly actuating the motor-generator.

In accordance with another embodiment, the drive which is coupled to the internal combustion engine and the drive of the transfer gearbox which is coupled to the motor-generator are arranged coaxially with respect to each other. In this way, it is for example possible to realize a fixed drive between the drive coupled to the internal combustion engine and the drive coupled to the motor-generator. The rotor shaft of the motor-generator and the drive shaft at the internal combustion engine end will then consequently exhibit the same rotational speed.

The drive train in accordance with the present disclosure can also comprise a control device in order to automatically control or regulate the power delivered from the motor-generator to the drive train and/or withdrawn from the drive train by the motor-generator, in particular in accordance with any one of the methods described below.

Another aspect of the present disclosure relates to a method for controlling a mobile crane drive train in accordance with any one of the embodiments described above, wherein the motor-generator is selectively actuated while the mobile crane is in motion, such that:
the motor-generator supplies power to the traction drive at the same time as the internal combustion engine, in particular at a high load, specifically when the internal combustion engine is at full load;
the motor-generator withdraws power from the traction drive in order to charge a rechargeable battery configured to supply power to the mobile crane, in particular as a function of the time available until the crane is next operated;
the motor-generator alone supplies power to the traction drive, in particular when the traction drive is geared down by the transfer gearbox; and/or
the motor-generator is switched off from delivering and/or receiving power as soon as an anti-lock braking system or brake control system engages at the chassis axles.

The motor-generator can, in particular, be actuated such that the rechargeable battery is charged as quickly as possible up to a predefined level of charge. The motor-generator can then, for example, be additionally actuated such that it does not deliver power to the traction drive. The motor-generator can also be actuated such that, taking into account the time available until the crane is next operated, it receives enough power from the drive train for the rechargeable battery to reach a predefined level of charge, in particular, a full level of charge, by the time the crane is next operated.

The motor-generator can also be actuated such that it supplies power to the traction drive, in particular, during acceleration or at a high load, such as for example when moving uphill. If the level of charge in the rechargeable battery is below a predefined value of for example 40%, the motor-generator can nonetheless be actuated such that it preferably charges the rechargeable battery and therefore does not deliver power to the traction drive, even when the combustion engine is subject to a higher load.

The motor-generator can charge the rechargeable battery while the mobile crane is coasting or decelerating and for the power thus received to help to slow the mobile crane. It is also possible for the motor-generator to no longer receive power from the drive train when a predefined level of charge in the rechargeable battery is reached, for example by separating the coupling between the transfer gearbox and the motor-generator or by correspondingly actuating the motor-generator by way of its power electronics.

The motor-generator can also be actuated such that it receives less than the maximum possible power during acceleration or at a substantially constant moving speed, so as not to affect the traction power and/or fuel consumption.

In accordance with another embodiment,
the power delivered by the motor-generator (when the motor-generator supplies power to the traction drive) and/or
the power received by the motor-generator (when the motor-generator receives power from the traction drive)
   is actuated as a function of at least one of the following variables:
the moving speed of the mobile crane;
the position of the brake pedal;
the position of the accelerator pedal or the load on the internal combustion engine;
the rotational speed of the internal combustion engine;
the current gearing-up ratio of the transmission, in particular a manual or automatic transmission, connected upstream of the transfer gearbox;
the switched state or gearing-down ratio of the transfer gearbox which is in particular a multi-stage transfer gearbox;
the respective temperature of the motor-generator, the rechargeable battery and/or components assigned to them;
the level of charge in the rechargeable battery; and
a predefined operating state and/or power profile of the crane and/or rechargeable battery, in particular selected by the driver or operator.

Another embodiment of the present disclosure envisages, as an alternative or addition to the power electronics varying how power is received or delivered, that the coupling between the transfer gearbox and the motor-generator is separated, in particular by opening a positive-fit coupling, as soon as the rechargeable battery has reached a predefined level of charge and the mobile crane has at least temporarily come to a stop.

The motor-generator can also serve to supply power to the mobile crane while the crane is being operated in such a way that the transfer gearbox or its outputs are not driving the chassis axles and are in particular idling and the transmission connected upstream of the transfer gearbox provides a predefined gearing-up ratio, wherein the motor-generator supplies power to electric drives of crane functions and/or to electrically operated crane components, in particular
indirectly via a rechargeable battery connected up between the motor-generator and the drives of the crane functions and/or
directly during an emergency operating mode of the drives of the crane functions which prevails when the rechargeable battery is faulty and/or depleted and/or when the temperature of the rechargeable battery is too high or too low.

Another aspect of the present disclosure relates to a mobile crane including a drive train as described above and including a control device configured to perform a method as described above.

### BRIEF DESCRIPTION OF THE DRAWINGS

The present disclosure is explained in more detail below on the basis of a preferred embodiment and by referring to the accompanying figure, wherein

FIG. 1 shows a mobile crane including a drive train in accordance with the present disclosure for supplying power to the traction drive.

### DETAILED DESCRIPTION

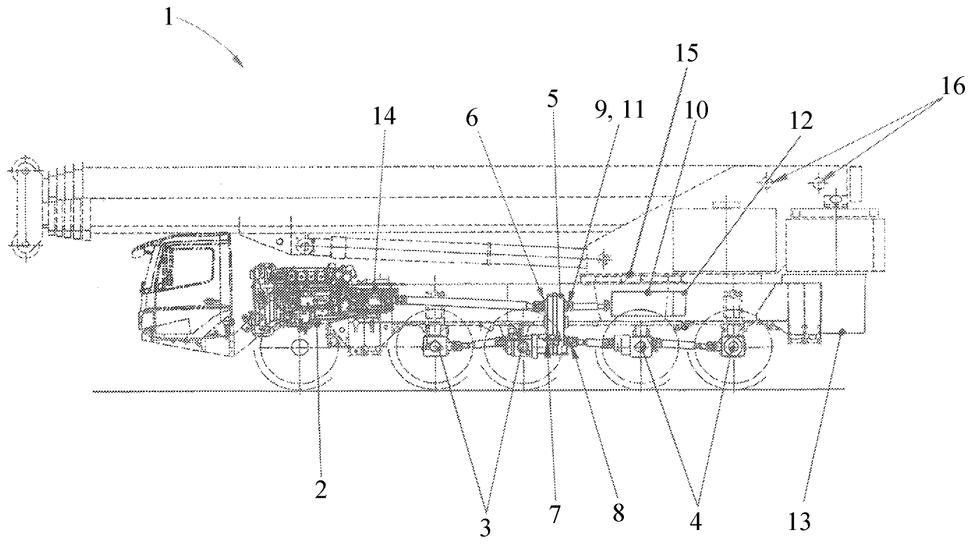

FIG. 1 shows a mobile crane 1 including an internal combustion engine 2 which is arranged in the undercarriage and drives the chassis axles 3, which are arranged in the front region of the crane undercarriage, and the chassis axles 4, which are arranged in the rear region of the crane undercarriage, via a manual or automatic transmission 14 and a transfer gearbox 5, wherein the drive train is designed such that the internal combustion engine 2 is connected to the transfer gearbox 5 via the drive 6, wherein the transfer gearbox 5 splits the power provided by the internal combustion engine 2 between the respective outputs 7 and 8 for the front chassis axles 3 or rear chassis axles 4.

The transfer gearbox 5 includes an additional output (PTO) or drive 9 which is arranged coaxially with respect to the drive 6 and via which, in accordance with the present disclosure, a motor-generator 10 is connected up to the transfer gearbox 5 and can therefore deliver power to or receive power from the drive train. In the example shown, the output or drive 9 can be mechanically separated from the motor-generator 10 by means of a claw coupling 11 and therefore no longer receives power from or delivers power to the drive train.

The rechargeable battery 13 which is arranged in the rear region of the crane undercarriage serves as an energy storage device. The control device 12 is configured such that it actuates or regulates the motor-generator 10 in accordance with the methods described above.

By means of the motor-generator 10, which in accordance with the present disclosure is connected up to the drive train for the traction drive, it is possible not only to assist the traction drive by way of an electromechanical converter in the form of the motor-generator 10. or even drive it entirely by way of the motor-generator 10 when moving in an off-road or crawling mode, but also to supply power to electric drives for crane functions while the crane is being operated. In the example shown, these crane functions include the electrically driven slewing mechanism 15 and the electrically driven winches 16 for the hoist mechanism and the auxiliary hoist mechanism, and can also include electrically driven hydraulic pumps, for example for telescoping and/or luffing the telescopic boom. This also enables electrical power to be supplied to other crane components, for example an electrically supplied thermal management system for heating and/or cooling crane components, the crane cabin and/or the rechargeable battery 13. For as long as the level of charge in the rechargeable battery 13 permits it, the traction drive and the crane functions can be operated entirely electrically and therefore emission-free, without having to run the internal combustion engine 2 or attach an external electrical power supply to the mobile crane 1 for this purpose. If the rechargeable battery 13 is no longer sufficiently charged to operate the crane autonomously and emission-free, and an external electrical power supply is also not available, the power needed to operate the crane functions 15, 16 can be provided by the internal combustion engine 2 and converted by the motor-generator 10.

1. A mobile crane drive train for supplying power to a traction drive of a mobile crane, comprising:
an internal combustion engine for providing drive power;
at least two driven chassis axles; and
a transfer gearbox which is arranged between the internal combustion engine and the chassis axles and splits the power provided by the internal combustion engine between the chassis axles and comprises a drive, which is coupled to the internal combustion engine, and two outputs which are each coupled to at least one chassis axle; and
wherein the transfer gearbox is coupled via at least one other drive to at least one motor-generator which is configured to selectively supply power to the drive train or receive power from the drive train.

2. The mobile crane drive train according to claim 1, wherein the transfer gearbox is permanently coupled to the motor-generator.

3. The mobile crane drive train according to claim 1, wherein the transfer gearbox is separably coupled to the motor-generator by a positive-fit coupling.

4. The mobile crane drive train according to claim 1, wherein the drive which is coupled to the internal combustion engine and the drive which is coupled to the motor-generator are arranged coaxially, wherein the transfer gearbox provides a fixed drive between the drive coupled to the internal combustion engine and the drive coupled to the motor-generator.

5. The mobile crane drive train according to claim 1, further comprising a control device configured to automatically control, the power delivered from the motor-generator to the drive train and/or received from the drive train by the motor-generator.

6. A method for controlling a mobile crane drive train according to claim 1, wherein the motor-generator is selectively actuated while the mobile crane is in motion, the method comprising:
supplying power to the traction drive, wherein the motor-generator supplies power to the traction drive at the same time as the internal combustion engine at a high load, when the internal combustion engine is at full load;
withdrawing power from the traction drive, wherein the motor-generator withdraws power from the traction drive to charge a rechargeable battery configured to supply power to the mobile crane as a function of time available until the crane is next operated;
supplying power to the traction drive, wherein the motor-generator alone supplies power to the traction drive when the traction drive is geared down by the transfer gearbox; and/or
switching the motor-generator off from delivering and/or receiving power as soon as an anti-lock braking system or brake control system engages at the chassis axles.

7. The method according to claim 6, wherein
the power delivered by the motor-generator when the motor-generator supplies power to the traction drive and/or
the power received by the motor-generator when the motor-generator receives power from the traction drive is actuated as a function of at least one of:
a moving speed of the mobile crane;
a position of the brake pedal;
a position of the accelerator pedal or the load on the internal combustion engine;
the a rotational speed of the internal combustion engine;
a current gearing-up ratio of a transmission connected upstream of the transfer gearbox, wherein the transmission is a manual or automatic transmission;
a switched state or gearing-down ratio of the transfer gearbox which is a multi-stage transfer gearbox;
a respective temperature of the motor-generator, the rechargeable battery and/or the components assigned to the motor-generator
and/or the rechargeable battery;
a level of charge the rechargeable battery; and
a predefined operating state and/or power profile of the crane and/or rechargeable battery selected by a driver or operator.

8. The method according to claim 6, wherein the coupling between the transfer gearbox and the motor-generator separated by opening a positive-fit coupling, as soon as the rechargeable battery has reached a predefined level of charge and the mobile crane has at least temporarily come to a stop.

9. The method according to claim 6, wherein operating the mobile crane such that the transfer gearbox or its outputs are not driving the chassis axles and the transmission connected upstream of the transfer gearbox provides a predefined gearing-up ratio, the motor-generator supplies power to electric drives of crane functions and/or to electrically operated crane components
indirectly via a rechargeable battery connected up between the
motor-generator and the drives of the crane functions and/or
directly during an emergency operating mode of the drives of the crane functions which prevails when the rechargeable battery is faulty and/or depleted and/or when the temperature of the rechargeable battery is too high or too low.

10. A mobile crane comprising:
a drive train according to claim 1; and a control device configured to control the drive train by selectively actuating the motor-generator while the mobile crane is in motion, wherein
the motor-generator supplies power to the traction drive at the same time as the internal combustion engine at a high load when the internal combustion engine is at full load;
the motor-generator withdraws power from the traction drive to charge a rechargeable battery configured to supply power to the mobile crane as a function of time available until the crane is next operated;
the motor-generator alone supplies power to the traction drive when
the traction drive is geared down by the transfer gearbox; and/or the motor-generator is switched off from delivering and/or receiving power as soon as an anti-lock braking system or brake control system engages at the chassis axles.

11. The mobile crane according to claim 10, wherein the power delivered by the motor-generator when the motor-generator supplies power to the traction drive and/or the power received by the motor-generator when the motor-generator receives power from the traction drive is actuated as a function of at least one of:
a moving speed of the mobile crane;
a position of the brake pedal;
a position of the accelerator pedal or the load on the internal combustion engine;
a rotational speed of the internal combustion engine;
a current gearing-up ratio of a transmission connected upstream of the transfer gearbox, wherein the transmission is a manual or automatic transmission;
a switched state or gearing-down ratio of the transfer gearbox which is a multi-stage transfer gearbox;
a respective temperature of the motor-generator, the rechargeable battery and/or the components assigned to the motor-generator and/or the rechargeable battery;
a level of charge in the rechargeable battery; and
a predefined operating state and/or power profile of the crane and/or rechargeable battery selected by a driver or operator.

12. The mobile crane according to claim 10, wherein the coupling between the transfer gearbox and the motor-generator is separated by opening a positive-fit coupling as soon as the rechargeable battery has reached a predefined level of charge and the mobile crane has at least temporarily come to a stop.

13. The mobile crane according to claim 10, wherein operating the mobile crane such that the transfer gearbox or its outputs are not driving the chassis axles and the transmission connected upstream of the transfer gearbox provides a predefined gearing-up ratio, the motor-generator supplies power to electric drives of crane functions and/or to electrically operated crane components
indirectly via a rechargeable battery connected up between the motor-generator and the drives of the crane functions and/or
directly during an emergency operating mode of the drives of the crane functions which prevails when the rechargeable battery is faulty and/or depleted and/or when the temperature of the rechargeable battery is too high or too low.
